(19) United States
(12) Patent Application Publication
(10) Pub. No.: US 2019/0305960 A1
(43) Pub. Date: Oct. 3, 2019

(54) METHOD AND SYSTEM FOR HUMAN-MEMORY BASED KEY GENERATION AND RETRIEVAL PROTOCOL

(71) Applicant: Lorand SZOLLOSI, Budapest (HU)

(72) Inventor: Lorand SZOLLOSI, Budapest (HU)

(21) Appl. No.: 15/953,455

(22) Filed: Apr. 15, 2018

(30) Foreign Application Priority Data
Mar. 30, 2018 (IN) 12742/2018

(51) Int. Cl. H04L 9/32; H04L 9/08

(52) U.S. Cl. CPC H04L 9/3247; H04L 9/3236; H04L 9/0869

(57) ABSTRACT

The various embodiments of the present invention provide a system for generating a private key and public key for an electronic signature to access and authenticate a data file. The system comprises a communication unit, a display, a secure input unit, and a secure processing unit. The communication unit comprises a storage of a document to be signed. The display is an input responsive connected to the communication unit. The secure input device is connected to the communication unit for managing a data flow of the document. The secure processing unit is connected to the communication unit and comprises a key generator computer readable program.

### BACKGROUND

### Technical Field of Invention

The present invention generally relates to an anti-counterfeiting method and system and particularly relates to a method and system for human-memory based key generation. The present invention more particularly relates to a method and system for a human-memory driven private-key and public-key generation for electronic signature of a data file to eradicate a necessity of saving sensitive information on a hardware.

### Description of Related Art

An electronic signature, or e-signature, refers to data in electronic form, which is logically associated with other data in electronic form and which is used by the signatory to sign. To be reliable, a signature system should provide non-repudiation, and verifiable evidence, that a person has correctly signed the required document at a particular time. It is a difficult task to verify the identity of a person who has signed a document as attacks on the integrity of the signing process may happen at any time during the signing process: from forging the signature, to combining a correct signature with an irrelevant document. When a document is signed, a party with fraudulent intent may record the signal generated at the signing using sensors and then use the recorded signal to create a forged signature. The attackers may also obtain a sample of a real, hand-applied signature, and manually imitate it. When transferring signatures, a fraudulent party may cut or copy signature data from a document and attach it to an irrelevant document. A receiver can also forge a printed document by forging the signature of the correct party on that document.

Electronic signature generation algorithms exist since at least [RSA 78]. Currently the most wide-spreaded signature protocols are RSA [RSA 78], DSA (DSS) [FIPS 186], and ECDSA [FIPS 186-4], used internally by BitCoin.

There are primarily 3 generations of electronic signature generation technologies:

PC (or Other Generic-Purpose Device) Signature Creation:

A PC, tablet or smartphone stores the private key of the user, usually in an encrypted way, protected by password. This is considered as highly insecure due to the fact that if the password is captured by an attacker through a malware or a cookie or a suitable inception, then can make a copy of the private key, thereby forging signatures even backwards in time. If the device is infected by a virus, then the key can be used to sign a document different than the one displayed to the user, thereby posing immeasurable risks.

Smart Card-Based Signature Creation:

A physical device stores the private key in a tamper-resistant memory, connecting to the terminal that displays the text to be signed via a channel which transmits only the document and the signature, not the private key. This process needs a device to be capable of creating signatures. While it seems as an advancement to the prior arts as the key cannot be captured, in reality it's equally vulnerable to an insecure terminal problem i.e. the terminal might display a different text than the one sent to the device for signature. This does not allow private key capture, but it allows forging of signatures on any document if the terminal is vulnerable.

TeDiES (Hungarian Patent P0401823) and VISA CodeSure (US20130048712 et. al.):

The Hungarian Patent P0401823 “Text-Displaying Electronic Signature Creation Device” provided a secure solution and eradicated the shortcomings of the prior arts. This device contained all the necessary elements of signature creation and verification. The device acted as a secure memory for the key, embedded in a microcontroller that's able to produce signatures and provided a tamper-resistant connection to a display for reviewing the text to be signed and a keypad to enter PIN code and control the process of document display and signature creation.

In the view of foregoing, there is a need for a method and system for generating a key without using a key storage thus eliminating a need for a hack-susceptible secure memory. Also, there is a need for a device for e-signature creation device, but requires storage of zero user-specific information during run time which will thwart any attempt of retrieving a user or key specific information even after stealing the device. Further, there is a need for a method and system for memory-based key generation for an electronic signature.

The above-mentioned shortcomings, disadvantages and problems are addressed herein, as detailed below.

### SUMMARY OF THE INVENTION

A primary objective of the present invention is to provide a method and system for generating a key without using a key storage.

Another objective of the present invention is to provide a method for generating public and private key without storing a user-specific information during run time.

Yet another objective of the present invention is to provide a method and system for memory-based key generation for an electronic signature.

The various embodiments of the present invention provide a system for generating a private key and public key for an electronic signature to access and authenticate a data file. The system comprises a communication unit, a display, a secure input device, and a secure processing unit. The communication unit comprises a storage of a document to be signed. The display is an input responsive audio-visual aid connected to the communication unit. The secure input device is connected to the communication unit for managing a data flow of the document. The secure processing unit is connected to the communication unit and comprises a key generator computer readable program.

According to one embodiment of the present invention, the communication unit comprises a secure storage memory for storage of a document to be input for signing and a signed document. The secure storage memory is accessible only by the secure processing unit.

According to one embodiment of the present invention, the document is presented on the display only after the secure processing unit is connected into the communication unit.

According to one embodiment of the present invention, the secure processing unit is associated with a unique identifier acting as an access code for displaying the document to be signed.

According to one embodiment of the present invention, the key generator computer readable program generates a public key and a private key in a real time based on a predefined set of query answers related specifically to a user.

According to one embodiment of the present invention, the set of query answers comprises a selection among displayed items comprising a set of words, pictures, and videos. The selection is either one or multiple choice per set.

According to one embodiment of the present invention, the set of query answers comprises a temporal-coded binary information further comprising a user specific complex rhythm, and a sequence of ‘taps’ used as answers to select an information from a temporal query.

The embodiments of the present invention provide a computer implemented method for generating a public key and private key for an electronic signature to access and authenticate a data file. The method comprises the steps of:
a) storing a user specific query list and answers;
b) detecting a presence of a secure processing unit;
c) initiating a key generation process comprising the sub-steps of:
   i) displaying a query list through a communication unit on a display;
   ii) receiving a set of query answers to create an entropy in response to the query list;
   iii) implementing an error correction code to the received entropy to generate an error-corrected entropy;
   iv) generating an uncorrelated entropy,
   v) generating an initialization vector (IV) of a cryptographically-secure pseudo-random number generator (CSPRNG) from the received entropy;
   vi) generating a public key and a private key through the generated IV;
d) receiving a document to signed on the display;
e) creating a document hash from the received document;
f) generating an electronic signature through the generated key;
g) signing the document through the generated electronic signature.

According to one embodiment of the present invention, the generated keys are same every time and scrapped after signing the document.

According to one embodiment of the present invention, the query list is arbitrarily chosen and presents a unique and non-repetitive sequence every time.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The other objects, features and advantages will occur to those skilled in the art from the following description of the preferred embodiment and the accompanied drawings in which:

FIG. 1 illustrates a flowchart for a method of generating a human-memory based key, according to one embodiment of the present invention.

FIG. 2 illustrates a block diagram for a system of generating a human-memory based key, according to one embodiment of the present invention.

### DETAILED DESCRIPTION OF THE DRAWINGS

In the following detailed description, a reference is made to the accompanied drawings that form a part hereof, and in which the specific embodiments that may be practiced is shown by way of illustration. The embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

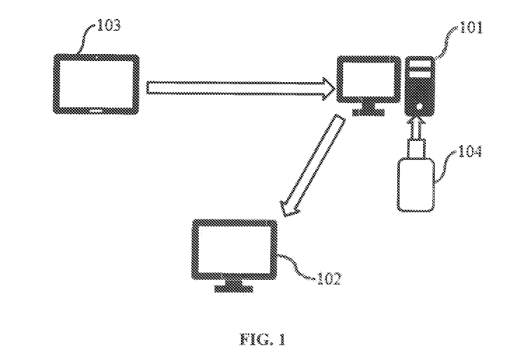

FIG. 1 illustrates a flowchart for a method of generating a human-memory based key, according to one embodiment of the present invention. With respect to FIG. 1, the system comprises a communication unit (101), a display (102), a secure input unit (103), and a secure processing unit (104). The communication unit (101) allows an input of a document proposed for signing and an output of signed document (or the signature) in a user understandable as well as computer readable format. The display (102) provides a viewable exhibit of the document to be signed. In a preferred embodiment, the display allows viewing only for the user(s) of the device (such solutions are e.g. virtual retinal display or head-mounted display). In another embodiment, the display is a textual or audio/visual display. The secure input unit (103) controls a flow of a presentation of the document and confirms or rejects a signature creation and an input of the query answers. In a preferred embodiment, the query answers are input as selections amongst displayed items (words, pictures) in either one per set or multiple choice per set format. In another preferred embodiment, the input is a temporal-coded binary information, e.g., a complex rhythm that the user knows or a sequence of ‘taps’ (answers) that selects words (or other information) from a temporal query (e.g. words of a song selected, yes-no answers to questions that are recorded). The secure processing unit (104) creates electronic signatures on connected with the communication unit and the secure input unit. In a preferred embodiment, the secure processing unit has internal memory that can be cleaned after the signature creation. The communication unit, the secure input unit, the display and the secure processing unit are connected in a way that external tampering is noticeable, an eavesdropping is practically impossible and the communication unit is completely under the control of the user (i.e. very low probability of external hacking or virus infection as the device is built for this specific purpose).

The communication unit comprises a storage of a document to be signed. The display is an input responsive connected to the communication unit. The secure input unit is connected to the communication unit for managing a data flow of the document. The secure processing unit is connected to the communication unit and comprises a key generator computer readable program.

According to one embodiment of the present invention, the communication unit comprises a secure storage memory for storage of a document to be input for signing and a signed document. The secure storage memory is accessible only by the secure processing unit.

According to one embodiment of the present invention, the document is presented on the display only after the secure processing unit is connected into the communication unit.

According to one embodiment of the present invention, the secure processing unit is associated with a unique identifier acting as an access code for displaying the document to be signed.

According to one embodiment of the present invention, the key generator computer readable program generates a public key and a private key in a real time based on a predefined set of query answers related specifically to a user.

According to one embodiment of the present invention, the set of query answers comprises a selection among displayed items comprising a set of words, pictures, and videos. The selection is either one or multiple choice per set.

According to one embodiment of the present invention, the set of query answers comprises a temporal-coded binary information further comprising a user specific complex rhythm, and a sequence of ‘taps’ used as answers to select an information from a temporal query.

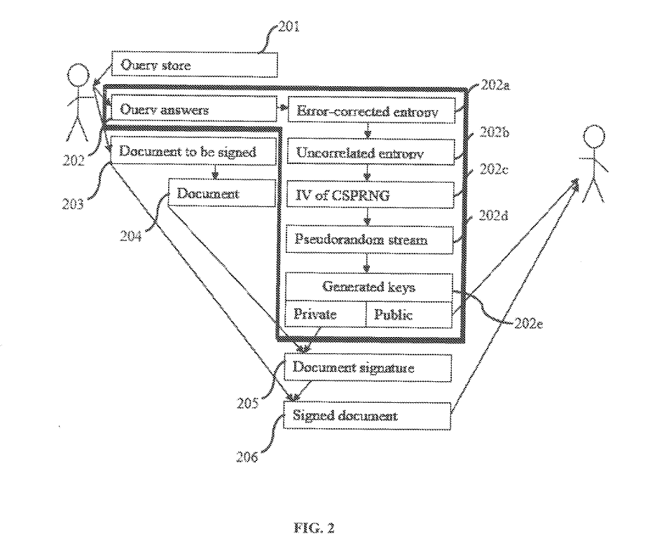

FIG. 2 illustrates a block diagram for a system of generating a human-memory based key, according to one embodiment of the present invention. With respect to FIG. 2, the method comprises the steps of:
a) storing a user specific query list and answers (201);
b) detecting a presence of a secure processing unit (202);
c) initiating a key generation process comprising the sub-steps of:
   i) displaying a query list through a communication unit on a display (202a);
   ii) receiving a set of query answers (pre-stored or freshly generated based on knowledge of user (past events, personal information, choices) to create an entropy in response to the query list (202b);
   iii) implementing an error correction code to the received entropy to generate an error-corrected entropy (202c);
   iv) generating an uncorrelated entropy (202d);
   v) generating an initialization vector (IV) of a cryptographically-secure pseudo-random number generator (CSPRNG) from the received entropy (202e);
   vi) generating a public key and a private key through the generated IV;
d) receiving a document to signed on the display (203);
e) creating a document hash from the received document (204);
f) generating an electronic signature through the generated key (205);
g) signing the document through the generated electronic signature.

According to one embodiment of the present invention, the generated keys are same every time and scrapped after signing the document.

According to one embodiment of the present invention, the query list is arbitrarily chosen and presents a unique and non-repetitive sequence every time.

The present method and system allows a secure key generation works without a key storage, hence eliminating the need for a secure memory. Although, the user still needs a reliable e-signature creation device, but this device stores zero user-specific information (when turned off, i.e., not during signing), therefore even stealing the device will not allow an attacker to forge signatures.

It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the claims.

I claim:

1. A system for generating a private key and public key for an electronic signature to access and authenticate a data file, the system comprises:
a communication unit, wherein the communication unit comprises a storage of a document to be signed;
a display, wherein the display is an input responsive audio-visual aid connected to the communication unit;
a secure input unit, wherein the secure input unit is connected to the communication unit for managing a data flow of the document;
a secure processing unit, wherein the secure processing unit is connected to the communication unit and comprises a key generator computer readable program.

2. The device as claimed in claim 1, wherein the communication unit comprises a secure storage memory for storage of a document to be input for signing and a signed document, wherein the secure storage memory is accessible only by the secure processing unit.

3. The device as claimed in claim 1, wherein the document is presented on the display only after the secure processing unit is connected into the communication unit.

4. The device as claimed in claim 3, wherein the secure processing unit is associated with a unique identifier acting as an access code for displaying the document to be signed.

5. The device as claimed in claim 1, wherein the key generator computer readable program generates a public key and a private key in a real time based on a predefined set of query answers related specifically to a user.

6. The device as claimed in claim 5, wherein the set of query answers comprises a selection among displayed items comprising a set of words, pictures, and videos, wherein the selection is either one or multiple choice per set.

7. The device as claimed in claim 5, wherein the set of query answers comprises a temporal-coded binary information further comprising a user specific complex rhythm, and a sequence of ‘taps’ used as answers to select an information from a temporal query.

8. A computer implemented method for generating a public key and private key for an electronic signature to access and authenticate a data file, the method comprises:
storing a user specific query list and answers;
detecting a presence of a secure processing unit;
initiating a key generation process comprising the sub-steps of:
displaying a query list through a communication unit on a display;
receiving a set of query answers to create an entropy in response to the query list;
implementing an error correction code to the received entropy to generate a error-corrected entropy;
generating an uncorrelated entropy;
generating an initialization vector (IV) of a cryptographically-secure pseudo-random number generator (CSPRNG) from the received entropy;
generating a public key and a private key through the generated IV;
receiving a document to signed on the display;
creating a document hash from the received document;
generating an electronic signature through the generated key,
signing the document through the generated electronic signature.

9. The method as claimed in claim 8, wherein the generated keys are same every time and scrapped after signing the document.

10. The method as claimed in claim 8, wherein the query list is arbitrarily chosen and presents a unique and non-repetitive sequence every time.
